(19) United States
(12) Patent Application Publication
(10) Pub. No.: US 2024/0042653 A1
(43) Pub. Date: Feb. 8, 2024

(54) METHOD FOR SEPARATION OF A PLASTIC ARTICLE

(71) Applicants: ARKEMA FRANCE, Colombes (FR); XCRUSHER, Strasbourg (FR)

(72) Inventors: Jean-Luc DUBOIS, Colombes, Cedex (FR); Abdelaziz BENTAJ, Villeneuve La Garenne (FR); Nicolas COUCHOT, Le Plessis Bouchard (FR)

(73) Assignees: ARKEMA FRANCE, Colombes (FR); XCRUSHER, Strasbourg (FR)

(21) Appl. No.: 18/256,682

(22) PCT Filed: Dec. 8, 2021
(86) PCT No.: PCT/FR2021/052241

§ 371 Date: Jun. 9, 2023

(30) Foreign Application Priority Data
Dec. 11, 2020 (FR) FR2013090

(51) Int. Cl. B29B 17/02

(52) U.S. Cl. CPC B29B 17/0206; B29B 2017/0227; B29B 2017/0293; B29B 2017/0262

(57) ABSTRACT

The invention relates to a method for separation of a polymeric article comprising at least one thermoplastic polymer, and at least one other constituent, wherein said separation method comprises: —a step of contacting the polymeric article with a liquid medium suitable for propagating shock waves, and —a step of applying a pulsed field to the liquid medium, so as to generate shock waves capable of dividing the polymeric article at an interface between the thermoplastic polymer and the other constituent.

The invention relates to the field of plastics, and more particularly to the field of the separation of one or more plastic article(s) which can be used in particular for recycling polymers. The invention relates in particular to a method for separation of a plastic article comprising a thermoplastic polymer.

The invention is useful in all industrial sectors faced with the problems of recycling such as end-of-life products, or industrial waste such as defective products or scrap originating from plastic processing operations.

### PRIOR ART

Plastics are widely used in various industrial sectors such as the transportation (motor vehicle, railway), health, wind power, nautical or aeronautical sectors. Thus, for many years now, hundreds of thousands of tonnes of plastic articles have been produced worldwide, and plastic production is expected to increase by 28.7 billion tonnes by 2050. As such, the production and recycling of plastic articles are clearly seen as major challenges from an environmental and economic perspective.

These plastic articles are characterized by a high level of diversity, with some articles comprising a combination of several polymers and other being in the form of composite materials (also referred to as “composites”), representing a macroscopic combination of at least two immiscible materials. Thus, recycling each type of plastic article presents different challenges and issues.

There are different recycling methods, such as thermal pyrolysis, selective dissolution, solvolysis, gasification and mechanical recycling. However, the products obtained after thermal, chemical or mechanical treatment are generally destined for applications where material performance is less exacting. Indeed, heat treatments generally involve the degradation of the polymer; that is to say that an increase in the temperature of the polymer can lead to the formation of undesired byproducts, especially when the heat treatment is carried out in the presence of impurities. Selective chemical dissolution treatments are complex to implement because they require taking account of all the constituents of the plastic article and their solubility parameters. Finally, conventional mechanical treatments can lead to the generation of numerous small impurities that can contaminate the thermoplastic polymer to be recycled, to degradations in the chain lengths of the polymers, and not all polymers are suitable for mechanical recycling.

In particular, poly(methyl methacrylate) (PMMA) is a well-established thermoplastic polymer known for its optical properties. Sold, for example, under the name Altuglas®, approximately 300 000 tonnes of PMMA are produced in Europe each year. Although PMMA can be converted back into monomers by thermal depolymerization, only approximately 30 000 tonnes of PMMA waste are collected for recycling each year in Europe. In addition, to a large extent, the recycling of PMMA in Europe currently relies on a lead-based process (molten lead bed) which does not make it possible to re-treat the inferior grades of PMMA (e.g. in the form of composites, contaminated with PVC or highly additivated), since these inferior grades lead to the formation of a large amount of solid residues contaminated with lead and to poorer yields of monomers.

It appears that the known methods for recycling articles comprising a thermoplastic polymer involve various heating steps which do not make it possible, in particular in the presence of a fibrous composite or a combination of polymers, to form high yields of quality monomers (i.e. with few, or no, contaminants and at a high degree of recovery, i.e. greater than 60%).

Indeed, as an example, during the production of plates cast from PMMA, the matrix to be polymerized is placed between two glass plates and surrounded by a flexible PVC (polyvinyl chloride) seal. PVC seals exist in different colours, shapes and thicknesses depending on the type of plate to be produced. In addition, after production, the plate may be covered in a protective film to prevent damage to the surface. Finally, the plate is cut up, a few centimetres or millimetres from the PVC seal, thereby generating PMMA waste that is contaminated with the PVC film and the protective film. The presence of PVC during depolymerization operations causes corrosion due to the production of HCl (hydrochloric acid) as the PVC degrades, but also also generates a number of byproducts such as methyl isobutyrate and other impurities that are difficult to separate from the methyl methacrylate (MMA) monomer of the PMMA. The PVC seal is usually separated from the PMMA by re-cutting production scrap as close as possible to the PVC seal. This is a manual operation that is long, painstaking and expensive and that also does not enable the PMMA to be recycled as close as possible to the production site. Thus, it is desirable to find solutions for effectively separating the PVC seal from the PMMA. Indeed, the PMMA is of excellent quality and could be recycled by thermal depolymerization if it were not contaminated by PVC.

Likewise, during operations for producing certain PVC objects, such as bathtubs, a PMMA plate is thermoformed, then a reinforcement made of glass fiber and adhesive, for example epoxy, is sprayed over the rear face, and finally the final shape is cut to the desired dimensions. The operations thus generate waste at the production sites but also at the end of life. In this case, the prior art solutions are generally to scrape the surfaces covered with glass fibers and adhesive (e.g. epoxy) in order to recover the PMMA-rich fraction. However, this solution is not entirely satisfactory because the operation is long and painstaking and always leaves some contamination on the surface of the PMMA. Moreover, since PMMA is a thermoplastic, local melting may take place by heating de to friction and it is therefore not possible to significantly accelerate the decontamination operations. It is therefore also desirable in this case to find a technology which would make it possible to separate the PMMA from the contaminants (adhesive and glass fibers).

Thus, from an energy and environmental perspective, it is desirable to have a separation method that enables improved recycling of thermoplastic polymers (i.e. higher yield and quality), whether said thermoplastic polymers are in composite form or combined with other polymers.

### Technical Problem

The invention thus aims to overcome the drawbacks of the prior art. In particular, the invention aims to propose a method for separating a polymeric article comprising at least one thermoplastic polymer for the repurposing of said at least one thermoplastic polymer. The method according to the invention enables improved separation of the thermoplastic polymer form the rest of the polymeric article. The method according to the invention makes it possible in particular for the thermoplastic polymer to be separated while minimizing contamination with foreign bodies which do not lead to significant heating of the polymer. The separated thermoplastic can then be recycled, for example by thermal depolymerization, thereby leading to a monomer composition of good quality.

The method according to the invention also contributes to a more environmentally-friendly and energy-efficient approach. The invention thus falls within a context of sustainable development and the repurposing of plastic waste, also referred to as polymeric articles.

### BRIEF DESCRIPTION OF THE INVENTION

To this end, the invention relates to a method for separating a polymeric article comprising at least one thermoplastic polymer and at least one other constituent, characterized in that said separation method comprises:
a step of bringing the polymeric article into contact with a liquid medium suitable for propagating shock waves, and
a step of applying a pulsed field to the liquid medium so as to generate shock waves that are able to divide the polymeric article at an interface between the thermoplastic polymer and the at least one other constituent.

The separation method makes it possible to divide a plastic article into its various components. In particular, a method according to the invention will be able to effectively separate a thermoplastic polymer from another constituent if there is an interface between the thermoplastic polymer, on the one hand, and the other constituent, on the other hand. For example, such an interface can take the form of a continuous plane of at least one cm², preferably of at least two cm². Under these conditions, the method according to the invention can lead to separation at this interface by virtue of selective, contact-free grinding. As will be described in detail hereinafter, the selective grinding will enable differential grinding between constituents of the plastic article. In particular, one of the constituents will be ground into smaller fragments than the others.

These components can then be repurposed or recycled without the difficulties associated with contamination. Indeed, the invention particularly advantageously makes it possible to separate the polymeric article at the interfaces thereof between the components thereof. This enables clear and precise separation. In addition, the invention has the notable feature of being able to differentiate a thermoplastic polymer from another constituent by changing the state of at least one of the two constituents (e.g. liquid/solid) or by dividing them into fragments that have dimensions such that the thermoplastic polymer can be readily separated from another constituent by conventional separation techniques.

Thus, the invention makes it possible to separate a polymeric article or plastic article into the various components thereof with high purity levels. Moreover, the invention enables selective contact-free grinding of the components of the polymeric articles.

The invention also enables automated separation, without manual intervention, of a polymeric article.

According to other optional features of the method, said method may optionally include one or more of the following features, alone or in combination:
the at least one other constituent corresponds to a reinforcement, preferably a fibrous reinforcement. Indeed, the invention is particularly well-suited to the separation, then recycling, of a composite article comprising a thermoplastic polymer and a reinforcement;
the step of applying a pulsed field is performed simultaneously with a step of dissolving the at least one thermoplastic polymer in the liquid medium. Thus, the shock waves propagate in the liquid medium until they reach the polymeric article and break it down, which facilitates bringing the at least one thermoplastic polymer, and even more preferably the PMMA, into contact with the liquid medium;
during the step of dissolving the at least one thermoplastic polymer, the liquid medium comprises at least one base monomer of the at least one thermoplastic polymer of the polymeric article. This makes it possible to quickly obtain a composition of base monomer of the at least one thermoplastic polymer having a low level of contamination with other polymers (e.g. less than 1% by weight). For example, the liquid medium may preferably comprise water and/or MMA;
the at least one other constituent corresponds to at least one second polymer, preferably to at least one second thermoplastic polymer. This may for example correspond to polyvinyl chloride as the second thermoplastic polymer, with PMMA as the first thermoplastic polymer;
the polymeric article comprises one or more interfaces, which are preferably continuous, between the at least one thermoplastic polymer and the at least one other constituent and the pulsed field is configured to target this or these interfaces. This increases the clear and precise division of the polymeric article at said interfaces. The pulsed field may be configured to target this interface, for example via a predetermined position of the electrodes and/or a means for positioning the polymeric article;
the at least one thermoplastic polymer is a polymer based on poly(methyl methacrylate), on polystyrene or on a mixture of these polymers. These polymers have the best performance in terms of separation, then recycling, in the context of the present method according to the invention;
the at least one thermoplastic polymer is a polymer based on poly(methyl methacrylate) having an average molar mass of less than 1 000 000 g/mol, preferably less than 600 000 g/mol, preferably less than 400 000 g/mol, preferably less than 200 000 g/mol. This is because the inventors determined that, in the presence of a reinforcement, lower molar masses enables recovery of a better quality of MMA (i.e. with contamination by other polymers of less than 1% by weight) at a better yield, in particular when a dissolution step is carried out. Thus, composite articles can be particularly effectively recycled by virtue of a separation method according to the invention;
the liquid medium corresponds to a dielectric liquid comprising water, an organic solvent, and/or at least one base monomer of the at least one thermoplastic polymer;
the step of applying the pulsed field comprises the use of a voltage of less than 200 kV;
the step of applying the pulsed field comprises the use of an energy of less than 70 MJ/kg;
the step of applying the pulsed field is carried out at a temperature of less than or equal to 80° C., preferably to 60° C., more preferably less than or equal to 50° C. The step of applying a pulsed field can additionally be preceded by a step of adding a polymerization inhibitor to the liquid medium.

The invention additionally relates to a method for treating a polymeric article comprising at least one thermoplastic polymer and at least one other constituent, characterized in that said treatment method comprises the separation of the polymeric article according to the invention, and
a step of eliminating the liquid medium, and
a step of sorting the at least one thermoplastic polymer and the at least one other constituent.

If the polymer is dissolved in its monomer, the treatment method can make it possible to directly obtain a syrup comprising a mixture of polymers and monomers which can in turn be used to make polymeric articles.

According to other optional features of the method, said method may optionally include a step of thermal depolymerization of the at least one thermoplastic polymer.

In addition, the method may comprise a step of treating the other constituent of the polymeric article.

Other advantages and features of the invention will become apparent on reading the following description given as an illustrative and nonlimiting example, with reference to the appended figures:

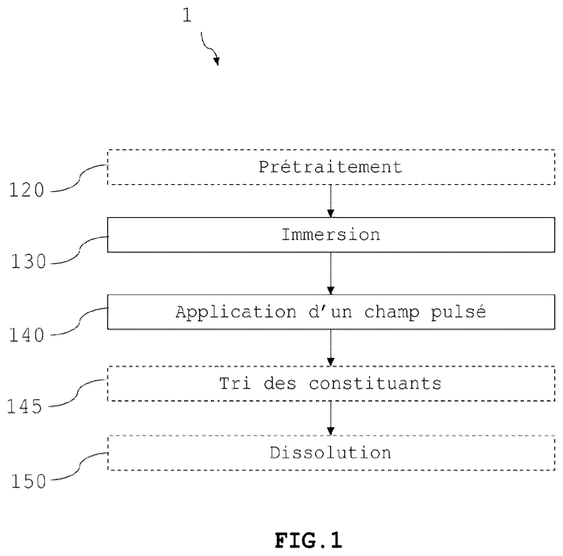

FIG. 1 shows a flow chart of the separation method according to one embodiment of the invention. The steps in boxes formed of dashed lines are optional;

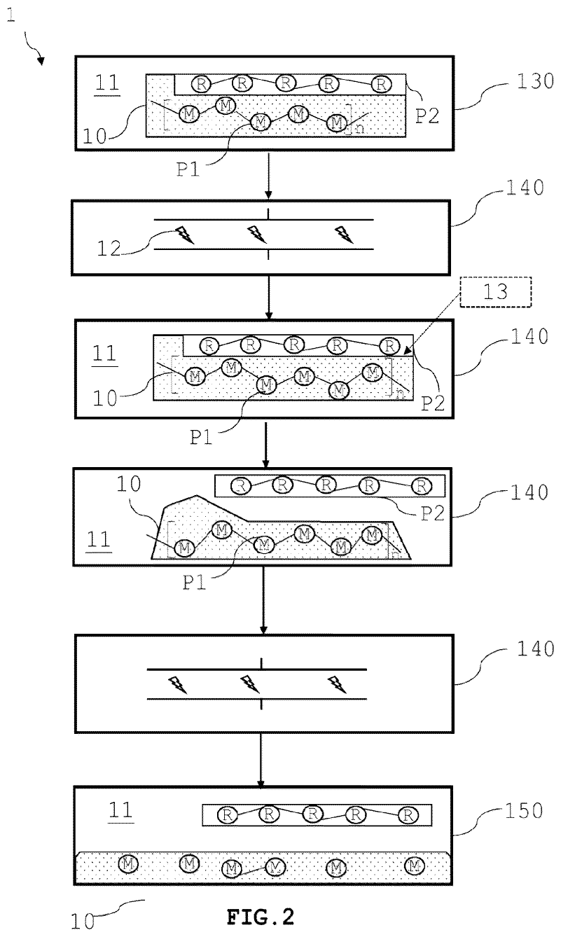

FIG. 2 shows a diagram illustrating the separation method according to one embodiment of the invention;

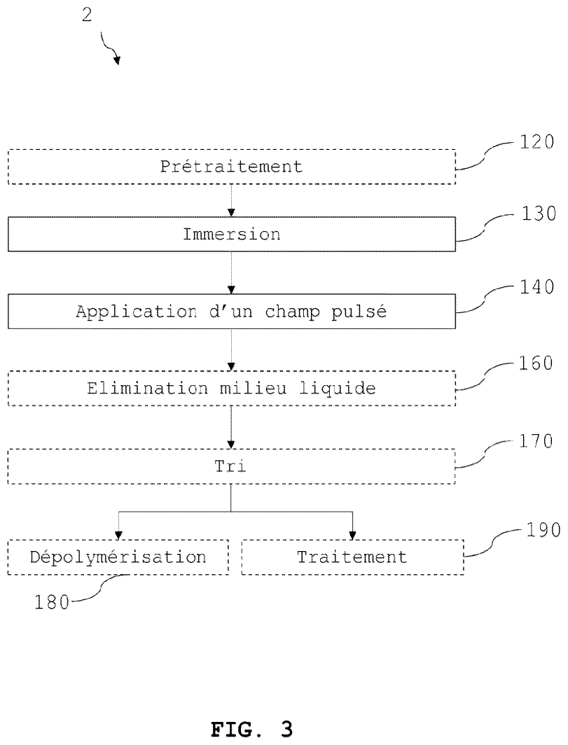

FIG. 3 shows a flow chart of the treatment method according to one embodiment of the invention. The steps in boxes formed of dashed lines are optional;

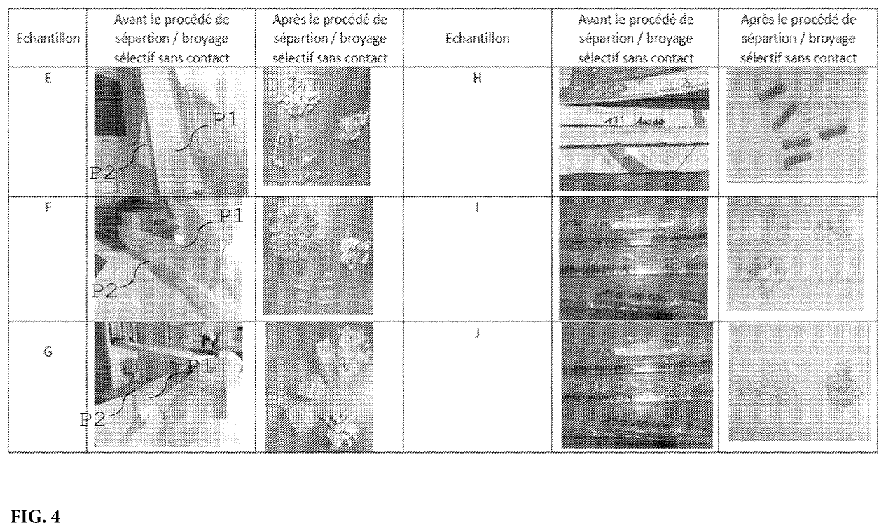

FIG. 4 shows several results of samples obtained following a separation and treatment method according to the invention.

Aspects of the present invention are described with reference to flow charts and/or block diagrams of methods according to embodiments of the invention.

In the figures, the flow charts and the block diagrams illustrate the architecture, the functionality and the functioning of possible implementations of systems and of methods according to various embodiments of the present invention. In this regard, each block in the flow charts or block diagrams may represent a system or a device for performing the specified function(s). In certain implementations, the functions associated with the blocks may appear in a different order to that indicated in the figures. For example, two blocks shown in succession may, in fact, be performed substantially simultaneously, or the blocks may occasionally be performed in the reverse order, depending on the functionality involved. Each block of the diagram and/or flow chart, and combinations of blocks in the diagram and/or flow chart, can be implemented by special physical systems which perform the specified functions or acts or carry out special material combinations.

### DESCRIPTION OF THE INVENTION

In the remainder of the description, the term “monomer” means a molecule which can undergo polymerization.

The term “polymeric article” as used relates to an object comprising at least one polymer, preferably combined with additives and/or fillers.

The term “depolymerization” as used relates to the process of converting a polymer into one or more monomer(s) and/or oligomer(s) and/or polymer(s) having a smaller average molar mass than the average molar mass of the initial polymer.

The term “base monomer” means the most predominant monomer unit constituting a polymer. Thus, in PMMA, the base monomer is MMA and in polystyrene the base monomer is styrene.

The term “thermoplastic polymer” or “thermoplastic” means a polymer which can be repeatedly softened or melted under the action of heat and which assumes new shapes by the application of heat and pressure. Examples of thermoplastics are, for example: high-density polyethylene (HDPE) particularly used for the production of plastic bags or for automotive construction; polyethylene terephthalate (PET) or polyvinyl chloride (PVC) which are particularly used for the production of plastic bottles; polystyrene (PS) used in the packaging and construction sectors; polymethyl methacrylate (PMMA). Thus, the use of thermoplastics affects a wide variety of sectors, ranging from packaging to the automotive industry, and the demand for plastics remains high.

The term “(meth)acrylic thermoplastic polymer” or “(meth)acrylic polymer” means a homopolymer or a copolymer based on (meth)acrylic monomer, which is selected, for example, from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, methacrylonitrile, methacrylamide and mixtures thereof. Poly(methyl methacrylate) (PMMA) is a particular example of a (methacrylic) polymer obtained by polymerization of a methyl methacrylate monomer.

For the purposes of the invention, the term “PMMA” denotes homopolymers and copolymers of methyl methacrylate (MMA), the weight ratio of MMA in the PMMA preferably being at least 70% by weight for the MMA copolymer. The term “copolymer based on methyl methacrylate” means a copolymer having at least one methyl methacrylate monomer. For example, a copolymer based on methyl methacrylate may be a copolymer comprising at least 70%, preferably 80%, advantageously 90% by weight of MMA in the PMMA.

For the purposes of the invention, the term “composite” means a multi-component material comprising at least two immiscible components, in which at least one component is a polymer and the other component may be, for example, a reinforcement such as a fibrous reinforcement or fillers.

The term “reinforcement” means a non-depolymerizable or gasifiable solid material such as a “fibrous reinforcement” or a “mineral filler” which generally remain at the end of recycling. The term “fibrous reinforcement” means an assembly of fibers, unidirectional rovings or a continuous filament mat, fabrics, felts or nonwovens which may be in the form of strips, webs, braids, strands or parts. In the context of the invention, a fibrous reinforcement will preferably correspond to a reinforcement comprising fibers greater than 10 mm, more preferably greater than 20 mm and even more preferably greater than 3 cm in length.

The term “mineral fillers” means all pulverulent fillers, for example quartz, marble, silica, aluminum hydroxide or titanium dioxide.

For the purposes of the invention, the term “substantially equal” means a value varying by less than 30% relative to the compared value, preferably by less than 20%, even more preferably by less than 10%.

For the purposes of the invention, “fragments of equivalent dimensions” means fragments having a substantially identical volume, i.e. a volume varying by less than 30% within fragments originating from the same constituent of the polymeric article, preferably by less than 20%, even more preferably by less than 10%. “Fragments of equivalent dimensions” can also mean fragments having at least two substantially identical dimensions, i.e. at least two dimensions varying by less than 30% within fragments originating from the same constituent of the polymeric article, preferably by less than 20%, even more preferably by less than 10%.

For the purposes of the invention, the term “interface” means a joining region between materials of different compositions that are solid at ambient temperature. A “continuous interface” refers for example to a joining region extending over a surface area of more than 1 cm², preferably more than 2 cm², more preferably more than 5 cm² and even more preferably more than 10 cm².

For the purposes of the present invention, “shock wave” means a disturbance occurring in a liquid medium which propagates in various forms within said medium. Since the propagation of pressure in the form of a wave is quick, this wave carries information regarding this disturbance into the liquid medium until it interacts with a solid (i.e. the polymeric article). A shock wave can therefore be a mechanical wave that, as it passes, subjects the medium in which it propagates to pressure, thereby enabling the polymeric article to be damaged by cracking or fracturing.

For the purposes of the invention, “metric” means an order of magnitude on the meter scale. Thus, an object of metric size can correspond to an object comprising at least one dimension of between 0.1 m and 10 m.

For the purposes of the invention, “centimetric” means an order of magnitude on the centimeter scale. Thus, an object of centimetric size can correspond to an object comprising at least one dimension of between 0.1 cm and 10 cm.

For the purposes of the invention, “millimetric” means an order of magnitude on the millimeter scale. Thus, a millimetric dimension can correspond to an object comprising at least one dimension of between 0.1 mm and 10 mm.

In the following description of the embodiments and in the appended figures, the same references are used to designate the same elements or similar elements. In addition, the various features presented and/or claimed may be advantageously combined. Their presence in the description or in the various dependent claims does not exclude this possibility.

The recycling of polymeric articles, and more so the separation of polymeric articles, require taking a number of parameters into account in order for this separation of polymeric articles to enable the recovery of a thermoplastic polymer, preferably PMMA, of good quality, for recycling, in particular by thermal depolymerization, in order to give a composition of monomer, preferably MMA, which is also of noteworthy quality.

In particular, for such a separation of polymeric articles, the technical problem to be solved is that of minimizing contamination with foreign bodies (i.e. fibers, fillers, additives, other polymers) while being automated and without significant heating of the thermoplastic polymer. The separation would be particularly advantageous if the other components of the polymeric article could also be recovered to be repurposed.

This is because the solutions conventionally employed consist, for example, in carrying out mechanical grinding, which gives rise to a number of byproducts, dust and other impurities that are difficult to separate, or consist of manual and/or mechanical cutting operations or heat treatments which are long, painstaking and expensive and which additionally leave behind contaminants; and which furthermore do not enable recycling or repurposing that is as close as possible to the production site. Moreover, these solutions are energy intensive and not environmentally friendly. The grinding operations can also generate dust and/or release fibers which can cause irritation for the operators.

Surprisingly, the inventors have discovered that when selective contact-free grinding is carried out, the separation of the polymeric articles is greatly improved thereby. This means that the quality (i.e. the absence of contaminants) is superior to what it would have been by carrying out depolymerization, grinding, or manual/mechanical separation of a polymeric article.

Thus, the inventors have developed a method for separating polymeric articles having improved quality (low level of contamination and high purity level), at high yield and with low energy consumption. In addition, the solution developed can be carried out at production sites or waste treatment sites. As will be presented in the examples, the quality of the separation is all the more noteworthy for some types of polymers, and particularly for thermoplastic polymers.

The present invention makes it possible to obtain satisfactory separation of polymeric articles, in particular starting from polymeric articles comprising at least one thermoplastic polymer and at least one other constituent.

The present invention thus in particular relates to a method 1 for separating a polymeric article 10.

For the purposes of the invention, a polymeric article 10 may correspond to an article comprising a polymer or polymers of different chemical compositions; thus, it may also be referred to as a plastic article.

Preferably, the polymeric article 10 comprises at least one thermoplastic polymer P1. These may be linear or branched polymers having a certain malleability, since thermoplastics regain their initial rigidity after cooling without the polymer being thermally degraded.

More particularly, the polymeric article 10 may comprise a thermoplastic polymer P1 based on poly(methyl methacrylate) (PMMA), on polystyrene or on a mixture of these polymers. Preferably, the thermoplastic polymer P1 is a thermoplastic polymer that is soluble in the monomer M thereof. For example, a thermoplastic polymer P1 based on PMMA is soluble in the monomer M thereof, MMA (methyl methacrylate) at a ratio of at least 100 kg of PMMA to 2 tonnes of MMA. Nevertheless, the solubility depends on the molar mass of the polymer, on the temperature and on the duration of dissolution.

Preferably, the polymeric article 10 comprises a (meth)acrylic thermoplastic polymer P1 which may be selected from polymers and copolymers of the acrylic family, such as polyacrylates. A thermoplastic polymer P1 is more particularly selected from polymethyl methacrylate (PMMA) or derivatives thereof or copolymers of methyl methacrylate (MMA) or mixtures thereof. Thus, the polymeric article comprises at least one thermoplastic polymer and preferably a (meth)acrylic polymer. In particular, such a PMMA can be the product that is sold by Arkema under the name Altuglas® and that comprises at least methyl methacrylate as a monomer.

The polymeric article 10 can also comprise at least one other constituent P2. One other constituent P2 may correspond to different chemical constituents.

Thus, one other constituent P2 may correspond to polymers such as thermoplastic polymers P3, preferably other than PMMA. By way of example, it may be a polymer from the chloropolymer family, and preferably polyvinyl chloride (PVC). It may thus be epoxy polymers based on acid anhydride, phenol or amine, polyamide. It may also be other polymers such as ABS or polycarbonates which are welded to the PMMA part and which must be separated to enable recycling. It may be a polymer (or paper) film placed on or adhesively bonded to the PMMA part. The polymer can thus be polyethylene, for example.

As will be presented in the examples, preferably, the polymeric article 10 comprises constituents such that the ratio of the impact strength of the at least one thermoplastic polymer to the thickness of the other constituent is less than 15.7, with preference less than or equal to 15, preferably less than or equal to 12.5. This is because this makes it possible to obtain better results regarding the selectivity of the pulsed-field treatment and makes it possible to obtain fragments that can be readily separated by constituent family. Thus, the method can advantageously comprise a step of selecting a polymeric article 10 comprising constituents such that the ratio of the impact strength of the at least one thermoplastic polymer to the thickness of the other constituent is less than or equal to 15.

In addition, comparing the results obtained for samples E, F, G, and I with the results obtained for sample J shows that the physical characteristics of the polymeric articles to be treated have an influence on the performance of the method.

One other constituent P2 according to the invention can also correspond to a reinforcement, and preferably a fibrous reinforcement R. A fibrous reinforcement R can generally refer to a plurality of fibers, unidirectional rovings or a continuous filament mat, fabrics, felts or nonwovens which may be in the form of strips, webs, braids, strands or parts.

A fibrous reinforcement R comprises an assembly of one or more fibers, generally a plurality of fibers, said assembly being able to have different forms and dimensions; one-dimensional, two-dimensional or three-dimensional. The fibers may be arranged randomly or parallel to one another, in the form of a continuous filament. The fibers may be discontinuous or continuous. When the fibers are continuous, the assembly thereof forms fabrics. Preferably, the fibrous reinforcement R is based on continuous fibers. A fiber is defined by its aspect ratio, which is the ratio between the length and the diameter of the fiber. The fibers used in the present invention are long fibers obtained from continuous fibers, or continuous fibers. The fibers have an aspect ratio of at least 1000, preferably at least 1500, more preferably at least 2000, advantageously at least 3000 and more advantageously at least 5000, even more advantageously at least 6000, even more advantageously at least 7500 and most advantageously at least 10 000. The continuous fibers have an aspect ratio of at least 1000. The dimensions of a fiber can be measured by methods well known to those skilled in the art. Preferably, these dimensions are measured by microscopy according to standard ISO 137.

The origins of the fibers constituting the fibrous reinforcement R may be natural or synthetic. Natural materials that may be mentioned include plant fibers, wood fibers, animal fibers or mineral fibers. Plant fibers are, for example, sisal, jute, hemp, linen, cotton, coconut, and banana fibers. Animal fibers are, for example, wool or fur. The mineral fibers may also be selected from glass fibers, in particular of type E, R or S2, basalt fibers, carbon fibers, boron fibers or silica fibers.

Synthetic materials that may be mentioned include polymer fibers selected from thermosetting polymer fibers, thermoplastic polymers or mixtures thereof. The polymer fibers may consist of polyamide (aliphatic or aromatic), polyester, polyvinyl alcohol, polyolefins, polyurethanes, polyvinyl chloride, polyethylene, unsaturated polyesters, epoxy resins and vinyl esters.

Preferably, the fibrous reinforcement R of the present invention comprises plant fibers, wood fibers, animal fibers, mineral fibers, synthetic polymer fibers, glass fibers, basalt fibers and carbon fibers, alone or in a mixture. More preferably, the fibrous reinforcement R of the present invention comprises carbon fibers or glass fibers. More preferably, the fibrous reinforcement R of the present invention substantially consists of carbon fibers or glass fibers (substantially meaning more than 50%).

The fibers of the fibrous reinforcement R have for example a diameter of between 0.005 μm and 100 μm, preferably between 1 μm and 50 μm, more preferably between 5 μm and 30 μm and advantageously between 10 μm and 25 μm.

Preferably, the fibers of the fibrous reinforcement R of the present invention are selected from continuous fibers for the one-dimensional form, or from long or continuous fibers for the two-dimensional or three-dimensional form of the fibrous reinforcement.

One other constituent P2 can also contain other constituents such as additives. For example, one other constituent P2 can correspond to carbon-based fillers. Carbon-based fillers may in particular be activated carbon, natural anthracite, synthetic anthracite, carbon black, natural graphite, synthetic graphite, carbon-based nanofillers or mixtures thereof. They are preferably selected from carbon-based nanofillers, in particular from graphenes and/or carbon nanotubes and/or carbon nanofibrils or mixtures thereof.

One other constituent P2 may also correspond to mineral fillers. The mineral fillers may in particular comprise metal hydroxides, which are more particularly in the form of alumina trihydrate (Al(OH)₃) or magnesium hydroxide (Mg(OH)₂) or magnesium oxide (MgO), calcium hydroxides and mineral fillers such as calcium carbonate, titanium dioxide, quartz, ground minerals or silica or mineral nanofillers such as nanotitanium dioxides or nanosilicas.

Thus, a polymeric article 10 according to one embodiment of the invention may correspond to a composite material comprising at least one thermoplastic polymer P1, preferably PMMA, and at least one other constituent P2 corresponding to a fibrous reinforcement R, preferably based on glass fiber for example.

Alternatively, a polymeric article 10 according to the invention may also correspond to at least one thermoplastic polymer P1, preferably PMMA, and at least one other constituent P2 corresponding to a second polymer P3; preferably, the second polymer is other than PMMA. The second polymer may for example correspond to polyesters, vinyl esters, epoxies (such as epoxy-amines), polyimides, polyurethanes, polyamides, high-density polyethylene, polyethylene terephthalates, polyvinyl chloride (PVC) or mixtures thereof. For example, the other constituent P2 may comprise a plurality of polymers, preferably at least two polymers, more preferably at least three polymers.

For example, it may be a polymeric article 10 comprising PMMA and PVC, or else PMMA, PVC and a fibrous reinforcement R based on glass fiber, or else PMMA, PVC, a fibrous reinforcement R based on glass fiber and an adhesive of epoxy type.

Preferably, and in order to benefit as far as possible from the advantages of the present invention, the other constituent may be present at a content of at least 5% by weight of the polymeric article 10, preferably at least 10% by weight of the polymeric article 10. As will be presented hereinafter, and in spite of these high contents, the method according to the invention makes it possible to generate a composition of thermoplastic polymer P1 which will comprise a content of other constituents of less than 1% by weight of the polymeric article 10, preferably of less than 0.5%.

As illustrated in FIG. 1, a method 1 for separating a polymeric article 10 according to the invention may comprise a prior step 120 of pretreating the polymeric article 10.

This pretreatment step 120 may comprise precutting the polymeric article 10, crushing, granulation, film removal, scraping, washing, drying, punching the polymeric article 10. Preferably, it may be precutting the polymeric article 10, comprising reducing the size of the polymeric article 10.

For example, the precutting of the polymeric article 10 may comprise cut sections of metric or centimetric dimensions.

A precutting step may for example be carried out by bandsaw, by pressurized water jet, by chopping, by circular saw, by guillotine, by crushing or by grinding.

Nevertheless, the prior precutting step 120 may be based on the dimensions of the polymeric article 10 itself, or else on the constraints of the location at which the method according to the invention is carried out. Thus, it may be precutting in order to obtain metric or centimetric sizes of the polymeric article 10.

The pretreated polymeric article 10 can then be introduced into a liquid medium.

Thus, a method 1 for separating a polymeric article 10 according to the invention may comprise a step 130 of bringing the polymeric article 10 into contact with a liquid medium 11.

The liquid medium 11 is advantageously suitable for propagating shock waves. Preferably, the bringing 130 of the polymeric article 10 into contact with the liquid medium 11 is a direct bringing into contact between the polymeric article 10 and the liquid medium 11. Direct bringing into contact means that there is no intermediary between the liquid medium 11 and the polymeric article 10. Thus, the liquid medium 11 touches the polymeric article 10. In other words, the polymeric article 10 is immersed 130 in the liquid medium 11. Advantageously, this is total or partial immersion 130, preferably total, of the polymeric article 10 in the liquid medium.

For the purposes of the invention, a liquid medium 11 can correspond to a dielectric liquid such as water or an organic solvent. It may be a single-phase liquid or preferably a two-phase liquid such as a mixture of water and MMA.

According to one embodiment of the invention, the liquid medium 11 may also advantageously comprise at least one monomer M of the at least one thermoplastic polymer P1. Thus, it may for example be a (meth)acrylic monomer, a monomer of acrylic acid, of methacrylic acid, an alkyl acrylic ester monomer, an alkyl methacrylic ester monomer, a hydroxyalkyl acrylic ester monomer or a hydroxyalkyl methacrylic ester monomer or a mixture thereof. More particularly, this (meth)acrylic base monomer may be methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, methacrylonitrile, methacrylamide and a mixture thereof.

Thus, a liquid medium 11 may comprise water and MMA, the MMA being sparingly soluble in water, which thereafter facilitates the recovery of the thermoplastic polymer P1 and/or of the base monomer M thereof. Other solvents can also be envisaged. Nevertheless, the flash point of the MMA and the autoignition temperature of the MMA are to be taken into consideration. Thus, the thermoplastic polymer or the other constituent will be able to dissolve in the solvent as the selective contact-free grinding takes place.

The liquid medium 11 may advantageously comprise a polymerization inhibitor. Preferably, the liquid medium 11 comprises a polymerization inhibitor that works in the presence of oxygen. It will advantageously be possible to use a polymerization inhibitor that works in the absence of oxygen if the method additionally comprises thermal depolymerization followed by a step of separating the monomers and the polymerization inhibitors. For example, it will be possible to select the polymerization inhibitor that works in the presence of oxygen from: hydroquinine (HQ); methyl ether hydroquinone or 4-methoxyphenol (MEHQ), or Topanol (2,4-dimethyl-6-tert-butylphenol). While it a polymerization inhibitor that works in the absence of oxygen can be phenothiazine.

The solvent may be selected such that the solubility parameters of the thermoplastic polymer P1 are as close as possible to the solubility parameters of the solvent. Furthermore, it is possible to use a pure body or a combination of a plurality of solvents to come closer to the solubility parameters of the thermoplastic polymer P1.

Preferably, it will be possible to select the solvent from: acetone, methyl ethyl ketone, ethyl acetate, N-methylpyrrolidone, dimethyl sulfoxide, methyl formate, isopropyl acetate, butyl acetate, cyclohexanone, butyl lactate, toluene, methylene chloride, chloroform, 1,2-dichloroethane, N,N-dimethylformamide, tetrahydrofuran and combinations thereof.

More preferably, it will be possible to select the solvent from: acetone, methyl ethyl ketone, toluene, cyclohexanone, methylene chloride, chloroform, tetrahydrofuran and combinations thereof.

When the polymeric article 10 to be recycled comprises PMMA and PE, the solvent is preferably selected from aromatic and non-aromatic hydrocarbons such as: pentane, trimethylpentane, hexane, heptane, xylenes, toluene, methyl oleate, limonene, isopropyl ether, ethylbenzene, dimethylcyclohexane, diisobutyl ketone, benzene, amyl acetate, chloroform, and mixtures thereof. Preferably, the solvent corresponds to a mixture of at least two aromatic and non-aromatic hydrocarbons selected from: pentane, trimethylpentane, hexane, heptane, xylenes, toluene, methyl oleate, limonene, isopropyl ether, ethylbenzene, dimethylcyclohexane, diisobutyl ketone, benzene, amyl acetate, chloroform. This is because such a solvent makes it possible to dissolve the polyethylene and not the PMMA. Thus, after the steps of immersion 130 and of applying a pulsed field 140, a sorting step will make it possible to easily separate the polyethylene present in the liquid phase from the PMMA which will have remained solid.

When the polymeric article 10 to be recycled comprises PMMA and polyamide, the solvent is preferably selected from: acetone, methyl ethyl ketone, toluene, methylene chloride, cyclohexanone, chloroform, and combinations thereof.

Alternatively, when the polymeric article 10 to be recycled comprises PMMA and polyamide, the solvent is preferably selected from: amyl alcohol, benzyl alcohol, cyclohexanol, 1,3-dioxolane, 2-butoxyethanol, isopentyl alcohol, 2-phenoxyethanol, 1-phenoxy-2-propanol, tetrahydrofurfuryl alcohol, and combinations thereof. In this case, the polyamide is dissolved.

Alternatively, the liquid medium 11 preferably comprises water.

This is because water is a dielectric liquid that makes it possible to propagate shock waves and advantageously makes it possible to reduce the risk of the explosion of the polymeric article 10 during the repeated application of a pulsed field. In addition, water has a particularly advantageous viscosity. The very low viscosity of water enables the shock waves to propagate readily in the water. Thus, a low-viscosity fluid (dynamic viscosity of less than 1×10⁻² Pa s at 20° C. under 1 bar), water in the present case, makes it possible to readily propagate the shock wave with very little energy dissipation by virtue of the low viscosity. The wave can thus reach the polymeric article 10 with very little energy having dissipated.

Indeed, the presence of salts dissolved in the water may modify the chemical/physical properties thereof (conductivity, viscosity, etc.), which may modify the effect of a pulsed field applied repeatedly. Thus, an optional step of desalination of the liquid medium may be provided. This can also be alleviated by washing the polymeric article during the pretreatment steps. Preferably, the liquid medium 11 has a conductivity of less than 2 mS/cm.

As mentioned previously, the separation method 1 according to the invention may comprise a step 140 of applying a pulsed field 12 to the liquid medium 11. The application 140 of a pulsed field 12 is preferably carried out by electrodes. These electrodes may be in direct or indirect contact with the liquid medium 11. Preferably, the electrodes are in direct contact with the liquid medium 11.

The application 140 of a pulsed field 12 to the liquid medium 11 makes it possible to generate shock waves. These shock waves may in particular be generated by the creation of an electrostatic field at the terminals of the electrodes, enabling the creation of an electric arc which can in turn generate a shock wave. In one embodiment, there are two electrodes. The electric field between the electrodes is high enough to exceed the breakdown voltage of the liquid medium 11. Breakdown generates an electric arc. The electrodes are submerged in the liquid medium 11. A plasma channel will be created between the electrodes. Because this plasma channel is conductive, it will enable a strong current to circulate. The effect of this is to raise the local temperature very rapidly, thereby generating an acoustic pulse or in other words a shock wave. These shock waves enable the creation of cracks in the immediate vicinity of the interfaces 13 of the polymeric article. Interface(s) 13 mean the line(s) separating the at least one thermoplastic polymer P1 from the at least one other constituent P2 of the polymeric article 10. The positioning of the pulsed field, and as a result the angle of incidence of the shock waves relative to the polymeric article, can make it possible to target these interfaces 13. For example, in the case of a composite with a fibrous fabric, the object or article is obtained by stacking resin-impregnated fabrics. While this gives a 3D object, it is made of lamellar structures. Consequently, it is advantageous to cause separation by delamination of the article. Each sheet of fibrous fabric can then be isolated and treated separately. To achieve this, since there is a preferential orientation of the product (article), it is desirable to present it in a preferential orientation in relation to the electrodes in order for the shock waves to propagate in the desired direction. This increases the clear and precise division of the polymeric article 10 at said interfaces 13 of the polymeric article 10. Thus, the application 140 of a pulsed field 12 and the propagation of the shock waves make it possible to target these interfaces 13. The shock waves reach the polymeric article 10 at the interfaces 13 thereof, and apply a force that is able to divide the polymeric article 10.

This is because the pressure applied by these expanding cracks exceeds the tensile strength of the polymeric article 10 and leads to the formation of gaps. If gaps have formed on contact with the shock waves, the liquid medium 11 can also penetrate therein and apply an additional force to the walls of said gaps. Advantageously, the nature, dynamics and intensity of formation of gaps are determined by the energy level in the cracks and by the properties of the polymeric article 10. The extension and number of gaps are correlated with the level of energy released. However, the number of gaps reaching the surface depends even more on the total energy released in the cracks. Consequently, it is possible to come to the conclusion that, in order to divide the polymeric article 10, a high pulse power is required; however, particularly advantageously, the separation method 1 according to the invention has selectivity, and consequently division, which is optimized by virtue of inhomogeneity (i.e. the different structure and composition of the fractions of the polymeric article), in particular by virtue of the acoustic inhomogeneities influencing the propagation of gaps in the polymeric article. Thus, the separation method 1 according to the invention does not consume much energy and makes it possible to target the interfaces 13 of the polymeric article 10, in order to divide it.

The separation method 1 according to the invention, and more particularly the application 140 of a pulsed field 12 to the liquid medium 11, makes it possible to create selective, contact-free grinding. Indeed, no additional means are necessary. The separation method 1 according to the invention relies on neither mechanical grinding nor manual techniques for the separation of the polymeric article 10.

The separation method 1 according to the invention makes it possible to grind the components of the polymeric article according to different dimensions. In particular, constituents of the same type (e.g. same polymer) form fragments of a similar dimension, said similar dimension being a different dimension to the dimension of constituents of another type (another polymer, reinforcement, etc.). In other words, the selective grinding corresponds to grinding of the at least one thermoplastic polymer P1 of the polymeric article 10 to form fragments of equivalent dimensions and of different dimensions to those of another, different constituent. In particular, the selective grinding corresponds to differential grinding between the constituents of the polymeric article 10 to form fragments of equivalent dimensions of another, different constituent, and of different dimensions to those of another, different constituent. The selective grinding depends on the mechanical properties of the different components forming the plastic or polymeric article. The component having the most fragile mechanical properties with regard to the shock wave will be the one predisposed to being ground. For example, with the at least one thermoplastic polymer P1 being ground to form fragments of equivalent dimensions, the fibers of the fibrous reinforcement R will be ground to dimensions that are equivalent to one another, while the polymers P3 will also be ground to dimensions that are equivalent to one another but with their dimensions, once ground, being different to the dimensions of the ground fibers or fragments of thermoplastic polymer P1.

In addition, repeating the pulses enables the shock waves newly formed by each pulse to interact with the growing cracks, which further increases the speed and efficiency of the separation method 1 according to the invention, since the cracks branch out toward other cracks or gaps that had already been formed. This branching can also depend on the angle of incidence of the shock waves.

Moreover, the waves generated according to the present invention are preferably shock waves. Indeed, a shock wave is characterized by a rapid transition; in this instance, this is a sudden transition in pressure. The pulse, and therefore the shock wave, diffuse in the polymeric article 10, which makes it possible to form cracks. This shock wave propagates in the liquid medium 11 and generates stress in the polymeric article 10. This then makes it possible to create gaps at the interfaces 13 of the polymeric article 10. This in turn leads to the division of the polymeric article 10 into its different components, P1, P2 and P3, and to the grinding of the components.

Thus, one of the significant advantages of the invention comprises grinding that is selective, optimized separation by division of the polymeric article, which is also contact-free since the shock waves make it possible to act on the polymeric article.

It is known that a shock wave is the propagation, in a physical medium, of a disturbance which moves at a rate that depends on the intensity of the disturbance causing it and which is gradually damped. This disturbance is characterized by a sudden change in pressure in the medium. The disturbance necessary to generate the shock wave, to grind and separate the elements constituting the polymeric article 10 to be treated, is generated by an electric discharge by pulsed power. Indeed, the generation of an electric discharge between at least two electrodes in a reactor that is receiving an ambient liquid and also the materials to be treated creates a plasma arc. The plasma arc acts as a very low-value resistor, which causes a short circuit. Currents of around a hundred amps up to tens of kiloamps can circulate in the plasma arc. These very high-intensity currents cause a sudden increase in the temperature in a relatively short space of time. This in turn causes a sudden increase in the pressure. This is the disturbance underlying the shock wave.

This mechanical shock wave propagates in the reactor by virtue of the ambient liquid which serves as the physical medium. The shape and dimension of the reactor are chosen on the basis of the materials and/or product to be treated. The mechanical energy transmitted by this shock wave to the ambient liquid is given by the equation:

$$E = \frac{1}{2} ρ {u}^{2}$$

where ρ is the density of the medium and u is the speed of the wave front. The intensity of the shock wave is proportional to the variation in the electric discharge current, because there is a relationship between the power supplied in the reactor and the variation in the electric discharge current:

$$\frac{dE}{dt} = {2 [ k \frac{{s}^{′2}}{3} {( \frac{di}{dt} )}_{t = 0} ]}^{\frac{2}{3}}$$

where i(t) is the electric discharge current in the circuit, and it is the distance between the two electrodes that generates the electric arc and the shock wave.

The energy of the shock wave can be written as follows:

$$E ( t ) = \frac{4 π {s}^{2}}{ρ c} {\int }_{0}^{t} {p}^{2} ( t ) dt$$

where ρ is the density of the medium, c is the celerity of the wave in the medium, s is the length of the arc channel generated, and p is the overpressure in the medium, which is given by the equation:

p(t)=p₀e^{-t/τ}

where p₀ is the maximum value of the overpressure produced by the shock wave and τ is a time constant which depends on the electrical modulus.

$${p}_{0} = \frac{1}{s} \sqrt{\frac{ρ cE}{2 πτ}}$$

It is therefore possible to determine the pressure of the shock wave at any moment during the propagation thereof in the ambient liquid.

The present invention takes advantage of this shock wave by placing the materials to be separated at a determined distance and position. This distance and position depend on the mechanical properties of the different components of the polymeric article, and on physical specificities such as the thickness. With the pressure of the shock wave at any moment being known, as well as the strength of the different materials, it becomes possible to obtain selective grinding.

Advantageously, the pulses have powers from 10 kV to 200 kV, preferably less than 200 kV, more preferably less than 150 kV and even more preferably less than 100 kV. The working frequency, i.e. the recurrence of the production of the shock waves, varies between 1 Hz and 20 Hz. The idle time between two consecutive electric discharges varies between 1 ms and 1 s. The frequency of the discharges forming a shock wave can be between 1 kHz and 300 kHz.

The shock waves generated can be transferred into the polymeric article 10 and can then cause detachment along the interfaces 13 of the polymeric article 10. The idle time between each new pulse can be between 1 millisecond and 1 second. The pulses can also have an energy of less than 90 MJ/kg, preferably less than 60 MJ/kg, more preferably less than 35 MJ/kg and even more preferably less than 20 MJ/kg. Indeed, the selective, contact-free grinding according to the invention makes it possible to consume the same amount of energy as mechanical grinding.

Preferably, the pulses can be guided through the polymeric article 10 at a temperature ranging up to 90° C., preferably up to 80° C., more preferably up to 70° C. and even more up to 60° C. The dynamic pressure can vary between 0.1 MPa and 50 MPa.

Advantageously, the temperature can be gradually increased during the step of applying the pulsed field 12. For example from 30° C. to 100° C., preferably from 30° C. to 80° C., with an increase of 10° C. per increment of 5 minutes. This is particularly advantageous because, since the method is carried out at a controlled, and low, temperature (i.e. less than 100° C.), this makes it possible to preserve the physical and chemical properties of the constituents of the polymeric article 10. For example, the method according to the invention makes it possible to retain the properties of the glass fibers, unlike the methods of the prior art where the articles are directly exposed to temperatures of greater than 300° C. Indeed, fibers, and particularly glass fibers, are temperature-sensitive; therefore, treatment at a low temperature (less than 100° C.) makes it possible to retain their properties.

Thus, the application 140 of a pulsed field 12 to the liquid medium 11 so as to generate shock waves makes it possible to divide the polymeric article 10 at at least one interface 13 between the thermoplastic polymer P1 and the other constituent P2, with the other constituent P2 retaining its properties.

As illustrated in FIG. 1, the method according to the invention may comprise a step 145 of sorting the constituents of the polymeric article 10.

This step may comprise the use of any means that enables solid/solid sorting and may comprise settling out, screening, triboelectric separation, or a combination of these methods.

According to a preferred but nonlimiting embodiment of the invention, a method according to the invention comprises a step 140 of applying a pulsed field 12 and a step 150 of dissolving the at least one thermoplastic polymer P1 in the liquid medium 11 comprising at least one base monomer M of the at least one thermoplastic polymer P1 of the polymeric article, as illustrated in FIGS. 1 and 2. In particular, the step 140 of applying a pulsed field 12 is performed at least partially simultaneously to a step 150 of dissolving the at least one thermoplastic polymer P1 in the liquid medium 11 comprising at least one base monomer M of the at least one thermoplastic polymer P1 of the polymeric article 10.

Indeed, particularly advantageously, the shock waves propagate in the liquid medium 11 until they reach the polymeric article 10 and break it down. This facilitates bringing the at least one thermoplastic polymer P1, and even more preferably the PMMA, into contact with the liquid medium 11. The liquid medium 11 then preferably comprises water and MMA.

Thus, in one embodiment in which the liquid medium 11 comprises the base monomer M of the thermoplastic polymer P1 of the polymeric article 10, for example MMA, this facilitates dissolution of the thermoplastic polymer P1 in the liquid medium 11. This dissolution can therefore be simultaneous to the step 140 of applying the pulsed field 12. This makes it possible to save energy and also time during the method 1 for separating the polymeric article. In addition, this is highly advantageous for the repurposing of the thermoplastic polymer P1 and the base monomer M thereof. In the context of recycling a polymeric article comprising polystyrene, the thermoplastic polymer P1 can then be polystyrene and the base monomer M thereof can be styrene.

Dissolution is particularly advantageous in the context of recycling products comprising reinforcements such as fibrous reinforcements. Indeed, in the context of composites, particularly of PMMA-carbon fiber or glass fiber, the presence of dissolution makes it possible to increase yields.

With the aim of recovering the various components of the polymeric article, the invention comprises a method 2 for treating a polymeric article 10 as illustrated for example in FIG. 3.

A method 2 for treating a polymeric article 10 may comprise a step 160 of eliminating the liquid medium 11.

The step 160 of eliminating a liquid medium 11 may comprise evaporation, filtration, thermal drying, microwave drying, draining or any other means that makes it possible to eliminate the more or less viscous liquid medium. Elimination of the liquid medium means reducing the volume occupied by said liquid, preferably until it disappears.

The step 160 of eliminating the liquid medium 11 preferably comprises the elimination of water.

The step 160 of eliminating the liquid medium 11, preferably water, makes it possible in particular to obtain one or more phases resulting from the separation method 1 according to the invention.

Thus, the step 160 of eliminating the liquid medium 11 may comprise obtaining a liquid phase that is rich in base monomer M and contains the dissolved thermoplastic polymer P1, preferably MMA and PMMA, a phase that is rich in thermoplastic polymer P2 or P3, a phase comprising one or more solid P2 or P3, a liquid phase that is immiscible with the base monomer of the thermoplastic polymer P2 or P3, and/or a gas phase P1, P2 or P3.

Alternatively, the method may comprise hydrolysis of the MMA to give methacrylic acid, which can be recycled.

The method 2 for treating a polymeric article may comprise a step 170 of sorting the at least one thermoplastic polymer P1 and the at least one other constituent P2. More specifically, the method 2 for treating the polymeric article 10 may comprise a step 170 of sorting the different phases obtained following the step 160 of eliminating the liquid medium 11.

Thus, depending on the different phases, different sorting steps 170 can be carried out.

For example, a sorting step 170 may comprise a separation by difference in density, by difference in solubility, by filtration or microfiltration, by particle size analysis, by difference in weight, by difference in triboelectric properties, by difference in adhesion, by viscosity, by coagulation, by settling out, by spinning, by drying, by lyophilization, by distillation, by condensation, by spectroscopic detection (infrared, Raman spectroscopy, X-ray analysis, etc.) or by any combination of these techniques.

Thus, following this sorting step 170, it is possible to recover the thermoplastic polymer P1, the base monomer M of the thermoplastic polymer P1, or a combination thereof.

The method 2 for treating the polymeric article 10 can also comprise a step 190 of treating the other constituent P2 of the polymeric article 10. A step 190 of treating the other constituent P2 of the polymeric article 10 may comprise any means enabling solid/liquid sorting, for example a screen. This step can also be performed by centrifugation using a centrifuge, or else by settling out, filtration, draining, spinning, pressing, screening or triboelectric separation. Preferably, the step 190 of treating the other constituent P2 of the polymeric article 10 comprises a prior filtration, centrifugation, or any other liquid/solid separation technique.

The method 2 for treating a polymeric article 10 can also comprise a step 180 of thermal depolymerization of the at least one thermoplastic polymer P1.

Such a step makes it possible to convert the thermoplastic polymer P1 into one or more monomer(s) and/or oligomer(s) and/or polymer(s) having a smaller average molar mass than the average molar mass of the initial thermoplastic polymer.

Advantageously, the products resulting from the depolymerization have improved quality, with a lower content of impurities, for example with a content of other constituents P2 of the polymeric article 10 of less than 1% by weight. In particular, when a constituent P2 is PVC, the method according to the invention may enable separation such that the mixture comprising the thermoplastic polymer P1 comprises less than 1% of PVC by weight, preferably less than 0.2% of PVC by weight.

In particular, when the thermoplastic polymer P1 is PMMA, the products resulting from the polymerization may have a content of methyl isobutyrate of less than 0.3% by weight.

Thus, the invention enables the simple and quick repurposing of at least one thermoplastic polymer P1, while not consuming much energy and being more environmentally friendly. The invention also enables improved separation of the thermoplastic polymer P1 from the rest of the polymeric article 10, such that the thermoplastic composition P1 is of good quality and can be recycled, for example by thermal depolymerization, thereby leading to a good quality monomer composition.

Particularly advantageously, the invention makes it possible to recover, at particularly high contents, the components of the polymeric article 10 with a very low content of contamination. For example, the thermoplastic polymer P1 or a composition comprising the base monomer thereof can be recovered with less than 1% by weight of PVC, preferably less than 0.5% by weight, preferably less than 0.2% by weight. The thermoplastic polymer P1 or a composition comprising the base monomer thereof can also be recovered with less than 10% by weight of fibers, preferably less than 5% by weight of fibers, preferably less than 2% by weight. The thermoplastic polymer P1 or a composition comprising the base monomer thereof can in particular be recovered with less than 5% by weight of adhesive, preferably less than 2% by weight of adhesive, preferably less than 1% by weight.

The invention will now be described in light of two specific but nonlimiting examples of the invention.

### Example 1: Composite Material Comprising a PMMA Matrix and a Fibrous Reinforcement Based on Glass Fiber

In the case of recycling PMMA and PMMA composites, the separation of the fillers and fibrous reinforcements is important in order to be able to repurpose the polymeric fraction. In addition, it is desirable to be able to separate the glass-fiber fibrous reinforcements at a low temperature, so as not to degrade the properties of the glass fiber.

In one embodiment of the invention, the composite materials are placed in a chamber in the presence of a single-phase, or preferably two-phase, liquid medium in which the discharges, using pulsed field technology, cause shock waves that propagate in the liquid medium until they reach the composite materials, particularly at the interfaces of the composite material. Preferably, these shock waves break down the PMMA while facilitating bringing the PMMA into contact with its monomer, MMA.

Next, using separation by density difference and by solubility difference, the solution of PMMA in its monomer MMA can be separated from the fibrous reinforcement and advantageously from the mineral fillers.

To this end, the composite materials are preferably introduced one-by-one, on a moving belt or conveyor belt, into a separation chamber.

The composite material can then undergo pretreatment, for example a reduction in the size thereof, in order in particular that the thickness of the material does not prevent propagation of the waves through said composite material.

The composite material is subsequently immersed in the liquid medium comprising the MMA monomer and a solvent (in this case water). This enables the material to be brought into contact with the liquid medium that is able to transport the shock waves (for example water and MMA, since the solubility of MMA in water is low).

A pulsed field is then applied under high voltage, generating the shock waves. Once the composite materials have been ground, the liquid medium is drained and dried so as to recover:
an MMA-rich liquid which contains the dissolved PMMA polymer
a solid is recovered by filtration; and optionally
a liquid phase that is immiscible with the MMA.

A step of treating the constituents of the polymeric article can then be implemented.

The PMMA can be recycled by thermal depolymerization of the polymer syrup obtained (PMMA in MMA).

The mineral fillers and fibrous reinforcements of the polymer matrix are preferably treated at low temperature. It is then possible to recover the glass fibers without them having lost their mechanical properties, unlike the method which would consist in the thermal depolymerization of the composite directly at temperatures of greater than 350° C. With the aim of removing the resin, the fibers can be washed, preferably in an aqueous medium, more preferably with water, then heated in an oven at 40° C. The fibers are thus freed of resin and can be repurposed.

### Example 2: Material Additionally Comprising a PVC-Type Polymer

During the production of plates cast from PMMA, the matrix to be polymerized is placed between two glass plates and surrounded by a flexible PVC seal. PVC seals exist in different colours, shapes and thicknesses depending on the type of plate it is desired to produce. In addition, they have Shore A hardnesses for example of between 70 and 90.

Finally, these PMMA plates can also have varied impact strengths, for example of between 10 and 50 kJ/m², varied flexural moduli or flexural strengths, for example of between 2000 and 3500 MPa at 23° C., tensile strengths of between 30 and 80 MPa at 23° C., or else Rockwell hardnesses of between M80 and M100. (Measured according to standard ISO 179, ISO 178, ISO 527, ISO 2039).

All these characteristics make the conventional mechanical and/or manual separation and recycling techniques more complex. This is because the means employed depend on each characteristic of the plates and seals, and the various types of scrap cannot therefore be treated in the same way.

In addition, at the end of polymerization, the plate is covered with a protected film in order to prevent damage to the surface, and the plate is cut up, a few centimetres or millimetres from the seal. This generates PMMA waste contaminated with the PVC seal and the protective film. Thus, the PMMA must be separated while minimizing contamination with foreign bodies.

One aspect of the technical solution of the invention consists in selective contact-free grinding by application of pulsed fields, regardless of the characteristics of the plates and seals, enabling selectivity based on the size of the ground compounds and improved separation of the PMMA and the PVC. In addition, it makes it possible to obtain a PMMA or MMA composition having contamination by PVC of less than 1% by weight.

In the implementation of the invention, firstly the PMMA plates with the PVC seal and protective film are placed on a conveyor belt to be conveyed to a reactor. They are then cut up, if they exceed the dimensions of the reactor.

The plates are introduced into the reactor that is filled with a Newtonian fluid. They are located at a specific distance, between 0.1 mm and 1 m, from the electrodes producing the shock wave. This distance is determined on the basis of the mechanical properties of the plates and also the thicknesses thereof.

PMMA articles (scrap from cutting cast plates) covered with a protective film are places in a chamber in the presence of a liquid medium in which the discharges (pulsed field technology) cause shock waves which propagate in the liquid medium until they reach the PMMA-PVC interface and break down the PMMA without significantly affecting the PVC. The plate scrap is preferably introduced one-by-one, on a moving belt or conveyor belt, into a separation chamber. The scrap may undergo pretreatment, for example a reduction in the size thereof.

Next, using particle size separation, the PVC can be separated from the PMMA by particle size sorting; this is because the PVC is hardly damaged by the shock waves according to the invention and, more particularly when it is colored, it is easy to detect.

Other techniques for separating the PVC can be envisaged, for example using the differences in triboelectric properties of the polymers, or using the differences in hot adhesion properties of the polymers, or else using sorting techniques coupled with spectroscopy (infrared, Raman or X-ray fluorescence).

The protective film is also separated from the PMMA and can be eliminated using separation by weight difference or density difference, for example by means of a blower (stream of air sweeping over the mixture of products after the selective grinding).

The liquid medium is preferably eliminated by drying and/or draining, and a step of treating the separated polymeric article can then be implemented.

The PMMA can then be recycled, for example by thermal depolymerization or by directly using the syrup of PMMA in MMA, or else by mechanical recycling.

The contact-free grinding is obtained by the transmission of shock waves (microexplosions) which can be adjusted in order to be focused on the PMMA-PVC interface and/or in the PMMA, with the PVC seal hardly being affected by the shock waves. The electrical energy used to produce the shock waves is between 20 and 20 000 joules and the working frequency (recurrence of production of the shock waves) varies between 1 Hz and 20 Hz. The idle time between two consecutive electric discharges varies between 1 ms and 1 s. By performing a number of rounds of between 1 and 5000, it is possible to grind the protective film and the PMMA to a particle size that enables separation of the PMMA from these. Targeted screening in the reactor makes it possible to facilitate separation at the end of the treatment. The number of rounds can be calibrated with respect to the thicknesses of the waste, but also with respect to the differences which may exist among the same materials (plasticized or non-plasticized PVC).

After having performed a number of rounds enabling the different elements to be separated, the ambient liquid is drained. The different elements are then sorted and dried. The PMMA, freed of the PVC and of the protective film, can be recycled by thermal depolymerization without producing HCl or any other byproducts originating from the film or the PVC.

The separation may be automated. The contamination of the PMMA with PVC is less than 1% by weight, which makes it possible to use the scrap obtained after grinding in units for the thermal depolymerization of PMMA.

Results of selective contact-free grinding are illustrated in FIG. 4. This figure shows in particular that the separation method makes it possible to generate fragments of thermoplastic polymer and other constituents in which the dimensions are generally different depending on the origin of these fragments. Thus, carrying out the method according to the invention makes it possible to generate fragments that are of similar dimensions for identical constituents and that can be differentiated from other constituents.

Table 1 below presents the characteristics of the polymeric articles on which the images in FIG. 4 are based.

TABLE 1

| | | | | Selectivity | |
|---|---|---|---|---|---|
| | | | | (i.e. | |
| | Impact | | | difference | |
| | resistance | | | in | Ratio of |
| | of the | Thickness | | dimensions | impact |
| | thermo- | of | Separation | between | strength/ |
| | plastic | the other | at the | the | thickness |
| Sample | polymer | constituent | interface | constituents) | of rod |
| E | RNC: 12 | Quite | + | + | 3-4 |
| | kJ/m² | thin | | | |
| | | 3-4 mm | | | |
| F | RNC: 20 | Medium | + | + | 2.5 |
| | kJ/m² | thickness | | | |
| | | 8 mm | | | |
| G | RNC: 20 | Very | + | + | 1 |
| | kJ/m² | thick 20 | | | |
| | | mm | | | |
| H | RNC: 30 | 3.5 mm | + | + | 8.6 |
| | kJ/m² | | | | |
| I | RNC: 50 | 4.0 | + | + | 12.5 |
| | kJ/m² | With | | | |
| | | protective | | | |
| | | film | | | |
| J (non- | RNC: 50 | 3.2 | + | − | 15.7 |
| selective) | kJ/m² | With | | | |
| | | protective | | | |
| | | film | | | |

Analysis of the results obtained over a series of polymeric articles shows that the method according to the invention does indeed make it possible to separate, in a contact-free manner, the constituents at the solid-solid interfaces between the constituents.

These results show that the method according to the invention makes it possible to isolate a PMMA polymer from the other constituents of a polymeric article and to thereby obtain, after treatment, a good quality PMMA or MMA composition having contamination of less than 1% by weight.

In addition, comparing the results obtained for samples E, F, G, and I with the results obtained for sample J shows that the physical characteristics of the polymeric articles to be treated have an influence on the performance of the method. Thus, better results (i.e. selectivity) are obtained when the samples treated comprise constituents such that the ratio of the impact strength of the thermoplastic polymer to the thickness of the other constituent is less than 15.7.

1. A method for separating a polymeric article comprising at least one thermoplastic polymer and at least one other constituent, wherein said separation method comprises:
a step of bringing the polymeric article into contact with a liquid medium suitable for propagating shock waves, and
a step of applying a pulsed field to the liquid medium so as to generate shock waves that are able to divide the polymeric article at an interface between the thermoplastic polymer and the at least one other constituent.

2. The separation method as claimed in claim 1, wherein the at least one other constituent corresponds to a reinforcement, preferably a fibrous reinforcement.

3. The separation method as claimed in claim 2, wherein the step of applying the pulsed field is performed simultaneously with a step of dissolving the at least one thermoplastic polymer in the liquid medium.

4. The separation method as claimed in claim 3, wherein, during the step of dissolving the at least one thermoplastic polymer, the liquid medium of the at least one thermoplastic polymer of the polymeric article.

5. The separation method as claimed in claim 1, wherein the shock waves are generated by the creation of an electric field at the terminals of the electrodes, enabling the creation of an electric arc which can in turn generate a shock wave.

6. The separation method as claimed in claim 5, wherein the electric field between the electrodes is high enough to exceed the breakdown voltage of the liquid medium.

7. The separation method as claimed in claim 5, wherein the electrodes are submerged in the liquid medium.

8. The separation method as claimed in claim 1, wherein the at least one other constituent corresponds to at least one second polymer, preferably to at least one second thermoplastic polymer.

9. The separation method as claimed in claim 1, wherein the polymeric article comprises one or more interfaces, which are preferably continuous, between the at least one thermoplastic polymer and the at least one other constituent and in that the pulsed field is configured to target this or these interfaces.

10. The separation method as claimed in claim 1, wherein the at least one thermoplastic polymer is a polymer based on poly(methyl methacrylate), on polystyrene or on a mixture of these polymers.

11. The separation method as claimed in claim 1, wherein the at least one thermoplastic polymer is a polymer based on poly(methyl methacrylate) having an average molar mass of less than 1 000 000 g/mol.

12. The separation method as claimed in claim 1, wherein the liquid medium corresponds to a dielectric liquid comprising water, an organic solvent, and/or at least one base monomer of the at least one thermoplastic polymer.

13. The separation method as claimed in claim 1, wherein the step of applying the pulsed field comprises the use of a voltage of less than 200 kV.

14. The separation method as claimed in claim 1, wherein the step of applying the pulsed field comprises the use of an energy of less than 70 MJ/kg.

15. The separation method as claimed in claim 1, wherein the step of applying the pulsed field is carried out at a temperature of less than or equal to 60° C.

16. The separation method as claimed in claim 1, wherein said separation method comprises a prior step of pretreating the polymeric article.

17. The separation method as claimed in claim 1, wherein said separation method comprises a step of sorting the constituents of the polymeric article.

18. The separation method as claimed in claim 1, wherein said separation method comprises a step of eliminating the liquid medium.

19. The separation method as claimed in claim 1, wherein the ratio of the impact strength of the at least one thermoplastic polymer to the thickness of the other constituent is less than 15.7, with preference less than or equal to 15, preferably less than or equal to 12.5.

20. The separation method as claimed in claim 1, wherein the other constituent is present at a content of at least 5% by weight of the polymeric article.

21. A method for treating a polymeric article comprising at least one thermoplastic polymer and at least one other constituent, wherein said treatment method comprises the separation of the polymeric article as claimed in claim 1, and
a step of eliminating the liquid medium,
a step of sorting the at least one thermoplastic polymer and the at least one other constituent, and
a step of thermal depolymerization of the at least one thermoplastic polymer.

22. The treatment method as claimed in claim 21, wherein said treatment method additionally comprises a step of treating the other constituent of the polymeric article.

23. The treatment method as claimed in claim 21, wherein the sorting step comprises a separation by difference in density, by difference in solubility, by filtration or microfiltration, by particle size analysis, by difference in weight, by difference in triboelectric properties, by difference in adhesion, by viscosity, by coagulation, by settling out, by spinning, by drying, by lyophilization, by distillation, by condensation, by spectroscopic detection (infrared, Raman spectroscopy, X-ray analysis, etc.) or by any combination of these techniques.
